(19) United States
(12) Patent Application Publication
(10) Pub. No.: US 2006/0106653 A1
(43) Pub. Date: May 18, 2006

(54) Reimbursement claim processing simulation and optimization system for healthcare and other use

(76) Inventor: Ellen R. Lis, Downingtown, PA (US)

Correspondence Address: Siemens Corporation;Intellectual Property Department, 170 Wood Avenue South, Iselin, NJ, 08830, US

(21) Appl. No.: 11/282,458

(22) Filed: Nov. 18, 2005

Related U.S. Application Data
(60) Provisional application No. 60/629,096, filed on Nov. 18, 2004.

(51) Int. Cl. G06Q 40/00

(52) U.S. Cl. 705/4; 705/39

(57) ABSTRACT

A system permits a healthcare provider to perform flexible, efficient, and timely multiple analyses of managed care organization (MCO) contracts, over a large database of historical information, to provide associated profitability information. An interface processor receives data representing multiple, different financial claims for reimbursement based on multiple, different predetermined reimbursement formulae. A source of data represents multiple calculable expressions. A repository includes data associating a particular calculable expression with multiple, different reimbursement formulae, and data associating particular financial claim data with particular reimbursement formulae. A data processor uses the repository to identify financial claim data of the data representing multiple different financial claims associated with particular reimbursement formula, and to initiate execution of a procedure comprising the particular calculable expression, derived from the source, to provide calculated data for use in determining reimbursement based on different reimbursement formulae.

### CROSS-REFERENCE TO RELATED APPLICATIONS

The present application is a non-provisional application of provisional application having Ser. No. 60/629,096 filed on Nov. 18, 2004.

### FIELD OF THE INVENTION

The present invention generally relates to computer information systems. More particularly, the present invention relates to a reimbursement claim processing simulation and optimization system for healthcare and other use.

### BACKGROUND OF THE INVENTION

Computer information systems (“systems”) include computers that communicate with each other over a network, such as the Internet, and computers that manage information. For example, a healthcare enterprise uses the systems to manage and simulate/model healthcare reimbursement claims and contracts. Such systems facilitate the analysis/profiling and contract modeling aspects of managed healthcare financing and delivery, including, for example, the capability of modeling net revenue and profitability for contract proposals. However, prior healthcare contract modeling systems lack flexible, comprehensive contract modeling capability and/or strong processing performance to support robust contract simulation.

A prior system employs a reimbursement calculation simulator that uses set-based, Structured Query Language (SQL)-driven processing to calculate reimbursement results for accounts in single-account increments. The prior system's contract management application provides contract simulations and modeling in reasonable timeframes as long as an input data set is kept small (e.g., less than 10,000 patient visits).

Although a contract simulator may support modeling of complex contracts, it has unacceptable processing performance. To compensate for the processing limitation, planners limit the amount of the historical input data entering the contract simulator. The limited input data provide a small set of non-randomly selected examples meeting contract reimbursement criteria, for example. During the analysis phase of a simulation, planners need to extrapolate and estimate the importance of the simulation's results against relevant historical information. A contract simulation approach that limits the input data to a relatively small sample is error prone. It can mislead planners both for and against a contract supposition, thereby encouraging planner to rely on non-scientific instincts and approximations.

Provider reimbursements and contract complexities have created a need for flexible, comprehensive, and robust quantitative analysis system that yields meaningful information to planners about the efficiency and effectiveness of their healthcare contracts. These services would assist health plans in evaluating provider reimbursement formulas, measuring contract profitability, and modeling comparisons between network contracts, for example. Accordingly, there is a need for a reimbursement claim processing simulation and optimization system for a healthcare application and other applications that overcomes these and other disadvantages of the prior systems.

### SUMMARY OF THE INVENTION

A financial claim-reimbursement simulation system includes an interface processor, a source of data, a repository, and a data processor. The interface processor receives data representing multiple, different financial claims for reimbursement based on multiple, different predetermined reimbursement formulae. The source of data represents multiple calculable expressions. The repository includes data associating a particular calculable expression with multiple, different reimbursement formulae, and data associating particular financial claim data with particular reimbursement formulae. The data processor uses the repository to identify financial claim data of the data representing multiple different financial claims associated with particular reimbursement formula, and to initiate execution of a procedure comprising the particular calculable expression, derived from the source, to provide calculated data for use in determining reimbursement based on different reimbursement formulae.

### BRIEF DESCRIPTION OF THE DRAWINGS

FIG. 1 illustrates a reimbursement claim processing simulation and optimization system for healthcare and other uses, in accordance with invention principles.

FIG. 2 illustrates a method of operation for the system, as shown in FIG. 1, in accordance with invention principles.

### DETAILED DESCRIPTION OF THE PREFERRED EMBODIMENTS

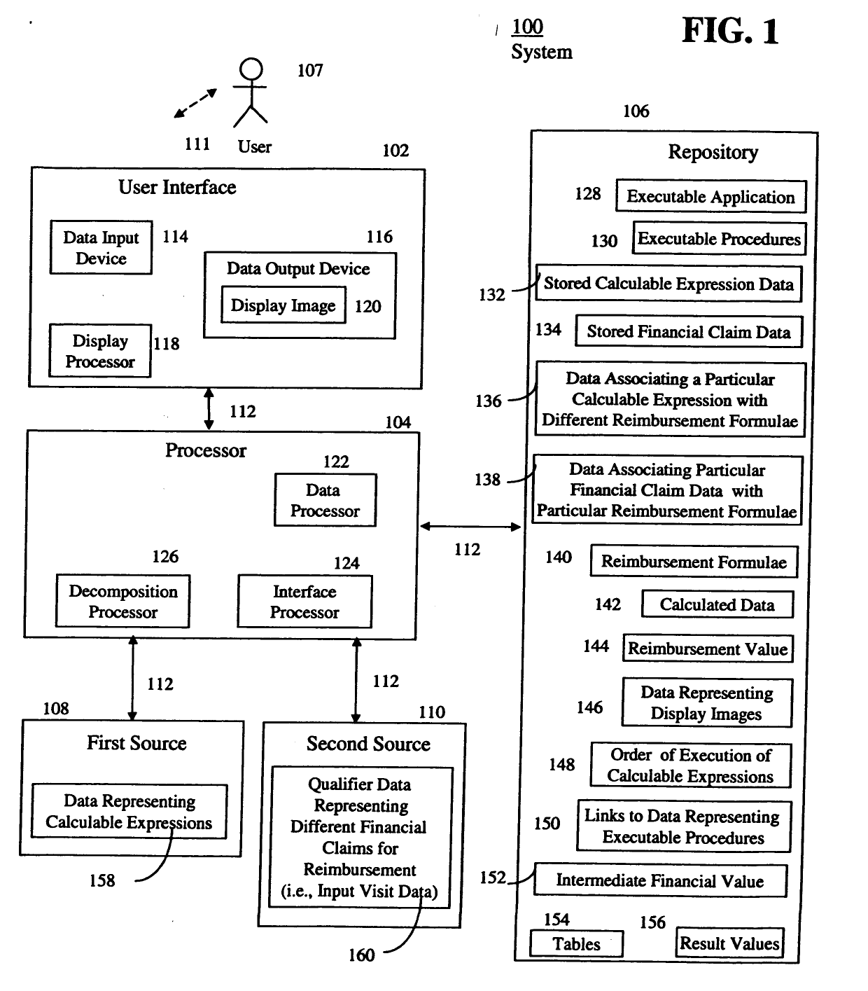

FIG. 1 illustrates a reimbursement claim processing simulation and optimization system (i.e., “system”) for healthcare and other uses. The system 100 includes a user interface 102, a processor 104, and a repository 106. A first source 108, a second source 110, and a user 107 interact with the system 100.

A communication path 112 interconnects elements of the system 100, and/or interconnects the system 100 with the remote system 108. The dotted line near reference number 111 represents interaction between the user 107 and the user interface 102.

The user interface 102 further provides a data input device 114, a data output device 116, and a display processor 118. The data output device 116 further provides one or more display images 120.

The processor 104 further includes a data processor 122, an interface processor 124, and a decomposition processor 126.

The repository 106 further includes an executable application 128, executable procedures 130, stored calculable expression data 132, stored financial claim data 134, data associating a particular calculable expression with different formulae 136, data associating particular financial claim data with particular reimbursement formulae 138, reimbursement formulae 140, calculated data 142, data representing display images 146, an order of execution of calculable expressions 148, links to data representing executable procedures 150, intermediate financial value 152, tables 154, and result values 156.

The first source 108 further includes data representing calculable expressions 158. The second source 110 further includes qualifier data representing different financial claims for reimbursement 160. The first source 108 may be the same as or different from the second source 110.

The system 100 may be employed by any type of enterprise, organization, or department, such as, for example, providers of healthcare products and/or services responsible for servicing the health and/or welfare of people in its care. For example, the system 100 may be used by managed care organizations (MCOs) to analyze large volumes of claims. In another example, the system 100 is applicable to insurance organizations for actuarial and statistical manipulation of large databases.

The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch.

The system 100 and/or elements contained therein also may be implemented in a centralized or decentralized configuration. The system 100 may be implemented as a client-server, web-based, or stand-alone configuration. In the case of the client-server or web-based configurations, the executable application 128 may be accessed remotely over a communication network.

The communication path 112 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 102 permits bi-directional exchange of data between the system 100 and the user 107 of the system 100 or another electronic device, such as a computer or an application.

The data input device 114 typically provides data to a processor in response to receiving input data either manually from a user or automatically from an electronic device, such as a computer or an application. For manual input, the data input device is a keyboard and a mouse, but also may be a touch screen, or a microphone and a voice recognition application, for example.

The data output device 116 typically provides data from a processor for use by a user or an electronic device, such as a computer or an application. For output to a user, the data output device 116 is a display, such as, a computer monitor (e.g., a screen), that generates one or more display images 120 in response to receiving the display signals from the display processor 118, but also may be a speaker or a printer, for example.

The display processor 118 (e.g., a display generator) includes electronic circuitry or software or a combination of both for generating the display images 120 or portions thereof in response to receiving data representing display images 146, which are stored in the repository 106. The data output device 116, implemented as a display, is coupled to the display processor 118 and displays the generated display images 120. The display images 120 provide, for example, a graphical user interface, permitting user interaction with the processor 104 or other device. The display processor 118 may be implemented in the user interface 102 and/or the processor 104.

The system 100, elements, and/or processes contained therein may be implemented in hardware, software, or a combination of both, and may include one or more processors, such as processor 104. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

Individually, the data processor 122 and the decomposition processor 126 performs specific functions for the system 100, as explained in further detail below, with reference to FIG. 1, and in further detail, with reference to the remaining figures. The interface processor 124 manages communication within the system 100 and outside the system 100, such as, for example, with the first source 108 and the second source 110. The data processor 122 also performs other general data processing for the system 100.

The repository 106 represents any type of storage device, such as computer memory devices or other tangible storage medium. The repository 106 may be implemented as a database. The repository 106 represents one or more memory devices, located at one or more locations, and implemented as one or more technologies, depending on the particular implementation of the system 100.

An executable application, such as the executable application 128, comprises machine code or machine readable instruction for implementing predetermined functions including, for example, those of an operating system, a software application program, a healthcare information system, or other information processing system, for example, in response user command or input.

An executable procedure, such as executable procedure 130, for example, is a segment of code (i.e., machine readable instruction), sub-routine, or other distinct section of code or portion of an executable application for performing one or more particular processes, and may include performing operations on received input parameters (or in response to received input parameters) and providing resulting output parameters.

A calling procedure is a procedure for enabling execution of another procedure in response to a received command or instruction. An object comprises a grouping of data and/or executable instructions or an executable procedure.

The system 100 manipulates large complex database tables and multiple contract requirements concurrently, so that complex mathematical calculations are performed within acceptable performance optimization. The system 100 provides managed care contract simulation and analysis optimization, while maintaining acceptable processing performance, to calculate a managed care contract's estimated reimbursement. The system 100 minimizes performance impacts associated with applying many contract terms against a large number of diverse patient groups.

Healthcare provider organizations use simulated calculations of expected reimbursement in a contract negotiation process to evaluate the bottom-line financial impacts of managed care renewal contracts, and proposed changes in contract terms. Since managed care contracts are often complex, the system 100 needs to access a substantial number of data sources for the required input. The set of contract terms to apply, and data sources to search, may vary substantially from patient to patient. Efficiently accessing data sources and applying contract terms is a non-trivial problem for a large population of patients receiving a wide range of provider services.

Features of the system 100 that advantageously optimize processing performance include, for example:

1) a large work unit size (e.g., 50,000 patient visits) for iterations of the calculation process;

2) a repository 106 including contract term data structured to facilitate translation into reimbursement calculation code;

3) program isolation of contract terms and qualification criteria into subsets that exclude unused information; and

4) mapping of visits to contract terms before calculating reimbursement amounts.

With simple and/or complex contracts, the system 100 provides comprehensive inclusion of relevant historical information as input, rather than an inaccurate sample, and achieves reasonably short processing times for calculation of simulated reimbursement results. The system 100 allows for processing speeds (e.g., about 250,000 visits/hour), which are twenty to fifty times higher than those of traditional contract management systems. The high processing speed increases customer satisfaction through improved quality of simulation and fewer healthcare claim rejections by payer organizations.

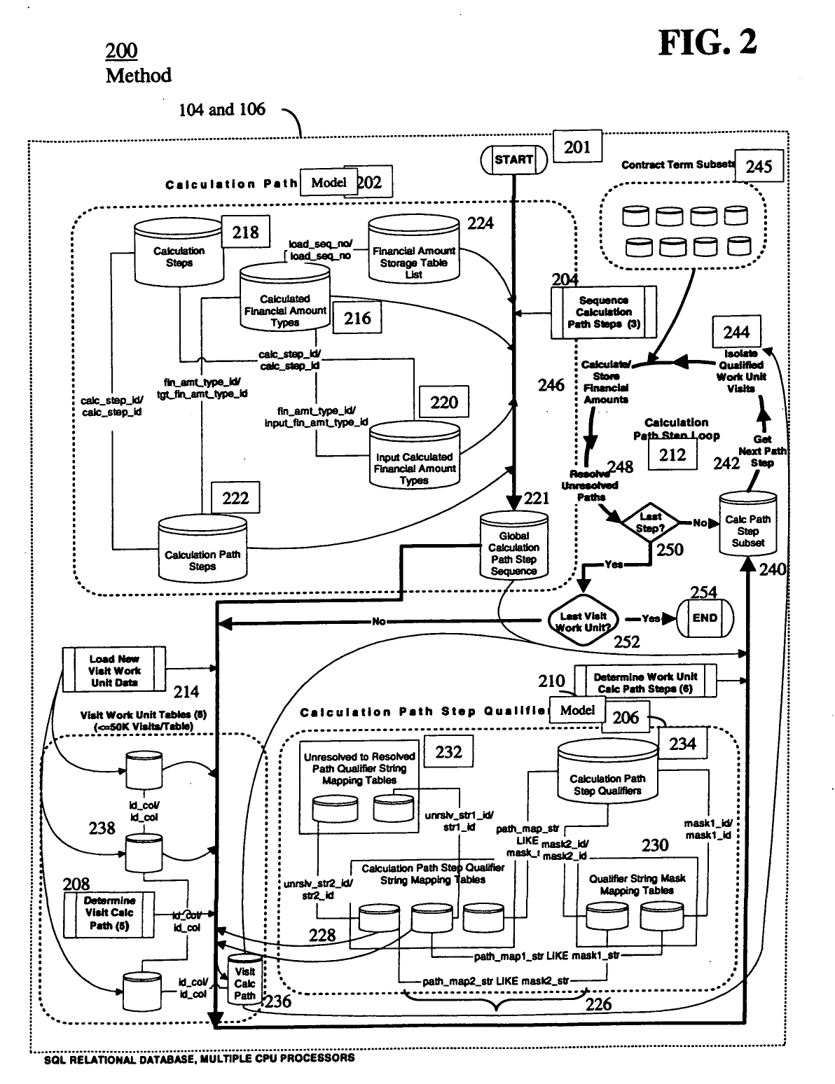

The system 100 uses data-model control tables, represented by tables 154 in FIG. 1 and stored in the database, and dynamically generated code, represented by executable procedures 130 in FIG. 1, to define and coordinate complex contract simulation calculations. The tables 154 include the Calculation Path Model 202 tables and Calculation Path Step Qualifier Model 206 tables, as shown in FIG. 2. Contract modeling applications employing the system 100 are adapted more readily to support changes in the methods used by MCOs to define reimbursement criteria and components of reimbursement formulae.

The system 100 enables individual patient-level reporting of reimbursement calculation details using the same process developed for high-volume contract simulations. The system's data-model tables permit formatting and organization of report calculation details, thereby improving the maintenance of report generation software.

In operation, the interface processor 124 receives data representing multiple different financial claims for reimbursement 160 based on multiple different predetermined reimbursement formulae 140. The data processor 122 uses (i.e., accesses or interfaces with) the repository 106 to identify financial claim data of the data representing multiple different financial claims associated with particular reimbursement formula 140. The data processor 122 also uses the repository 106 to initiate execution of an executable procedure 130 employing a particular calculable expression 132 derived from the source 108 to provide calculated data 142 for use in determining a reimbursement value 144 based on different reimbursement formulae 140. There is a one-to-one relationship between a calculation expression and a calculation path step 222, as shown in FIG. 2.

The data processor 122 initiates concurrent execution of executable procedures 130 comprising the different reimbursement formulae 140. At any time in the calculation process, the data processor 122 executes one executable procedure or multiple concurrent executable procedure instances. The data processor 122 calculates reimbursement formulae with shared calculation path steps in parallel.

The executable procedure 130 needed to execute a calculable expression 132 may be a subsection of the procedure or module executed. The system 100 uses data in the repository 106 to determine which subsection executed is associated with the calculation path step(s) using the calculable expression 132.

The executable procedure 130 is sequentially executed, one calculation path step at a time, with concurrent calculation of intermediate results for reimbursement formulae 140 referencing the calculation path step's calculable expression 132.

The data processor 122 initiates concurrent execution of executable procedures 130 comprising the particular calculable expression 132 derived from the source 108 to provide calculated data 142 for use in determining a reimbursement value 144 based on different reimbursement formulae 140.

A reimbursement formula 140 involves multiple calculable expressions executed in a predetermined order. The repository includes data identifying the order of execution 148 of the multiple calculable expressions 132. The data processor 122 uses the order identification data 148 derived from the repository 106 to initiate execution of executable procedures 130 comprising the multiple calculable expressions 132 derived from the source 108 in the predetermined order.

The repository 106 includes links 150 to data representing the executable procedures 130 comprising the multiple calculable expressions 132. The data processor 122 uses the links 150 to initiate execution of the executable procedures 130.

The decomposition processor 126 automatically decomposes the multiple different predetermined reimbursement formulae 140 into component calculable expressions. The decomposition processor 126 performs this function, for example, by parsing formulae and using character matching.

The data associating the particular financial claim data with the particular reimbursement formulae 138 comprises data representing financial claim qualifying conditions, such as contract terms, for example.

The execution of the procedure 130 comprising the particular calculable expression 132 provides an intermediate financial value 152 for use by a second calculable expression in a reimbursement formula The intermediate financial value 152 is provided to the second calculable expression, and the second calculable expression provides a second financial sum value used in deriving a reimbursement sum value in accordance with the reimbursement formula 140. The value 152 can be a Min/Max/Sum aggregate, an equality/financial amount type conversion step, a difference, or the result of some other arithmetic computation.

The second calculable expression in the reimbursement formula uses multiple result values provided by multiple different calculable expressions including the intermediate financial value 152 from the particular calculable expression.

The data associating a particular calculable expression with multiple, different reimbursement formulae 136 and the data associating particular financial claim data with particular reimbursement formulae 138 are stored within tables 154 in the repository 106.

FIG. 2 illustrates a method 200 of operation for the system 100, as shown in FIG. 1. The method 200 employs the processor 104 and the repository 106, including various elements of which are shown in FIG. 2.

The method starts at step 201. The method 200 includes a Calculation Path Model 202, a Calculation Path Step Sequencer 204, a Calculation Path Step Qualifier Model 206, a Patient Visit And Calculation Path Step Qualifier String Assignor 208, a Work Unit Calculation Path Step Determiner 210, a Calculation Path Step Loop 212, and a Patient Visit Work Unit 214. The elements 202-214 further include additional elements, as shown and described herein.

The repository 106, implemented as a relational database using, for example, employs a computer language, such as Structured Query Language (SQL), for example, to create, modify, and retrieve data from the relational database. The repository 106 includes software program code (e.g., the executable application 128 and the executable procedures 130), input patient visit data (i.e., qualifier data representing different financial claims for reimbursement 160), and data models (i.e., association data 136 and 138).

The SQL software program code 128 and/or 130 and input visit data reside in the relational database 106 to efficiently apply reimbursement terms against large datasets in a database.

The system 100 employs a query performance feature called concurrent computing, otherwise called parallel computing or parallelism. Concurrent computing is the simultaneous execution of the same task (e.g., split up and specially adapted) on multiple processors in order to obtain faster results. Concurrent computing may occur when SQL code executes against database tables in a database server supported by multiple processors. If a query (i.e., a specification of a result to be calculated from a database) chosen for a SQL statement is optimal, individual processors produce a separate, parallel-running thread that performs a portion of the work of the SQL statement simultaneously. SQL database tables are indexed in ways that encourage a query optimizer to choose access paths involving parallelism. A benefit of parallelism is that a SQL statement being processed by multiple processors completes in less time compared to a SQL statement handled by one processor. A benefit of storing detail patient visit data 134 and contract term data in a SQL database 106 is the capability to subset and re-index the detail patient visit data 134 and contract term data, as needed, in intermediate working tables, to encourage use of optimal access paths and parallelism.

In the Calculation Path Model 202, components of a reimbursement calculation formula are modeled as a set of Calculation Path Steps 222 tied to: input data sources 108 and 110, intermediate output tables 154, and program code 128 and 130 for populating the intermediate output tables 154. Components of the Calculation Path Model 202, and the associated software program code, may be shared across the Calculation Path Steps 222. Program code 128 and 130 use one or more Calculation Path Models 202 to concurrently perform processing tasks.

An individual calculation paths is an ordered series 148 of calculable expressions 132 to be executed as calculation path steps. The end result of these ordered executions is a reimbursement value 144, and the amounts calculated during execution of earlier steps in the sequence are intermediate financial amounts 152.

A calculation step 218 is different from a calculation path step 222. A calculation step 218 definition sets the types of input amounts to use, and the calculation expression performed on the input. A calculation path step 222 has the characteristics of a calculation step 218, however the output financial amount of a calculation path step is typed, to serve as input for specific later calculation path steps 222.

Identifiers of a Calculation Path Model's 202 components are stored in SQL database tables 154. Component labels are used as module input parameters to activate applicable software program code.

Various interfaces may be used to populate the Calculation Path Model 202. The system 100 features a set of requirements for the table 154 in the Calculation Path Model 202, associated code for generating a global sequence of reimbursement formula components supporting multiple formulae 138, and a parameter-based paradigm for associating individual steps of this global sequence to calculation code (i.e., calculable expression data 132) 136. These features of the system 100 may be used for other methods of reimbursement by changing the contents of tables in the Calculation Path Model 202 to support the new methods. Contents of the Calculation Path Model 202 are described as follows.

Types of Intermediate Calculated Financial Amounts 216 (i.e., intermediate financial value in FIG. 1) are used in the input or output of a final stage of a calculation step 218. Financial amounts having a Calculated Financial Amount Type 216 are calculated using different subsets of the Global Calculation Path Step Sequence 221. Individual Calculated Financial Amount Types 216 serves as an output for an instance of a calculation step 218, or as an input for instance(s) of later calculation step(s) 218. Results for individual Calculated Financial Amount Type 216 reside in one of the Financial Amount Storage Tables 224.

The Calculation Steps 218 for a reimbursement calculation include the following attributes:

1) Mathematical and/or logical operation performed for the final stage of the calculation step (e.g. multiplication, aggregation, financial type reassignment).

2) Type of SQL operation (e.g., INSERT or UPDATE) used in the final stage of the calculation step that updates the target Financial Amount Storage Table 224 for an instance of the step.

3) Calculation Step Input Data Specification for the component 220, described below.

Instances of a Calculation Step 218 within a reimbursement calculation retain the global attributes of the Calculation Step 218. The output associated with instances of a Calculation Step 218 cover multiple Calculated Financial Amount Types 216. However, individual instances of a Calculation Step 218, within a calculation path, produce results for a Calculated Financial Amount Type 216.

A Calculation Step Input Data Specification defines input data for the Calculation Step 218 as follows:

1) A list of source database tables. These may be tables populated in earlier phases of a calculation step 218.

2) Relational connections between source database tables in the above list.

3) Qualifier filter criteria, used in the INSERT or UPDATE statement of the Calculation Step 218, which updates the target table of the step in a Financial Amount Storage Table Ust 224.

4) A “GROUP BY” clause, if applicable, for calculations involving aggregation to produce a sum, minimum, or maximum of a set of input values.

5) Input Calculated Financial Amount Type(s) 220 contained in the source database tables serving as input.

A calculation step input data specification may also be implemented in program code comprising SQL variables used in dynamic construction of INSERT/UPDATE code for the final stage of the Calculation Step 218. This is the approach used for the system calculation step input data specifications.

A Calculation Step Input Data Specification is relatively inflexible. Two things may vary in this specification. The first is a variable containing the sequence number of the Calculation Path Step 222 currently being processed. This variable is directly related to components in the Calculation Path Step Qualifier Model 206 that determine the set of input patient visits to healthcare institutions qualifying for the step. This variable is standard and is included in the qualifier filter criteria of the Calculation Step Input Data Specification. If the Calculation Step 218 is associated with one or more optional Calculation Path Steps 222, specification of the Calculation Path Step sequence number variable is not sufficient to accurately isolate visits qualifying for the Calculation Path Step 222. For Calculation Steps 218 called by optional Calculation Path Step(s) 222, additional Qualification filter criteria, specific for the current Calculation Path Step, need to be added to the list of existing Qualifier filter criteria for the Calculation Step 218.

The input calculated financial amount types 220 link the information in the tables of components 216 and 218 to specify which Calculated Financial Amount Types 216 serves as input for the Calculation Step 218.

The Calculation Path Steps 222 links information in the tables of components 216 and 218 to specify which Calculated Financial Amount Types 216 may serve as output for an instance of a Calculation Step 218. Individual rows in this table uniquely identify a Calculation Path Step 222 as a combination of Calculation Step 218 and Output Calculated Financial Amount Type 216. Other metadata in the table indicate whether the path step is logical (i.e., does not require program code execution, and exists to support path step sequencing), or optional (i.e., not fully covered by the Calculation Path Step Qualifier Model 206). If a Calculation Path Step 222 is optional, the SQL statement “WHERE” clause in the calculation step's input data specification need to contain additional filter criteria, for qualifying visits, that depend on the value of the Calculation Path Step 222 sequence number variable used in the WHERE clause. The processing covered by code linked to a Calculation Path Step 222 is not limited to SQL statements affecting the Financial Amount Storage Tables 224. Other stages of processing before and after financial amount storage table updates may be covered by the linked program code. The Calculation Path Model 202 is flexible in allowing the modeler to use discretion to determine which processing steps, and financial amount intermediates, need to be explicitly called in the model. For the system 100, the primary reasons for including certain financial amount intermediate calculations in the Calculation Path Model 202 are to support performance, and to meet requirements for patient level revenue calculation report content and display format in the display images 120 (see FIG. 1).

The Financial Amount Storage Table List 224 includes a list of intermediate tables to store calculated results for one or more Calculated Financial Amount Types 216. The intermediate tables, load, order, and process large amounts of set-based data against those tables that are used in execution of a calculation path step.

The list 224 includes a load sequence order number used in the Calculation Path Step Sequencer 204, code populating the table of the Global Calculation Path Step Sequence 221. From steps of the global calculation path, different sets of calculation path steps can be combined to represent a reimbursement formula 140. Individual Calculated Financial Amount Type's 216 data are assigned to one of these storage tables. The design and use of financial amount storage tables need to support the global calculation path in that the order of loading of the storage tables need to correspond to path step execution order.

The Global Calculation Path Step Sequence 221 is a table containing a unique processing sequence number, for individual Calculation Path Steps 222, of the Calculation Path Model 202. The system 100 populates table 221 by applying SQL program code of the Calculation Path Step Sequencer 204 to data in tables of components 216, 220, 222, and 224.

The Calculation Path Step Sequencer 204 uses data in certain Calculation Path Model 202 tables to populate the table of the Global Calculation Path Step Sequence 221.

The Calculation Path Step Qualifier Model 206 contains criteria for determining the subset of an input patient visit population that qualifies for a Calculation Path Step 222. The model is represented in SQL database tables. The system 100 builds a Calculation Path Step Qualifier Model 206 and links it to input patient visit data 134 in the reimbursement calculation reimbursement formulae code 140. Tables in the Calculation Path Step Qualifier Model 206 have the following contents.

In Calculation Path Step Qualifier Strings 226 (e.g., path_map1_str LIKE mask1_str), a qualifier string is a character representation of multiple patient visit attributes that qualify the patient visit for a valid sequence of Calculation Path Steps 222. These strings 226 are stored in Calculation Path Step Qualifier String Mapping Tables 228. A character of a Calculation Path Step Qualifier String 226 contains a coded answer to a question, indicating whether a member of the input population (e.g., a visit) meets a certain criterion for one or more Calculation Path Steps 222. Possible answers include: “Y” yes, “N” no, “?” undetermined, and “_” not applicable.

Calculation Path Step Qualifier String Mapping Tables 228 are tables relating Calculation Path Step 222 patient visit qualification criteria to characters of a Calculation Path Step Qualifier String 226. A Calculation Path Step Qualifier Model 206 may contain one or more types of Calculation Path Step Qualifier Strings 226, with one Calculation Path Step Qualifier String Mapping Table 228 per type of string. A row of a Calculation Path Step Qualifier String Mapping Table 228 contains a mapping for one Calculation Path Qualifier String 226.

Qualifier String Mask Mapping Tables 230 are used when the number of Calculation Path Qualifier Strings 226 in a Calculation Path Step Qualifier String Mapping Table 228 is too large to be used directly in the specification of visits qualifying for a Calculation Path Step 222. Wildcard masks (i.e., n-bit quantities) used in these specifications are stored in a Qualifier String Mask Mapping table 230 to determine which bits should be ignored.

Unresolved to Resolved Path Qualifier String Mapping Tables 232 are used for some reimbursement calculations when the full calculation path cannot be fully determined prior to the start of reimbursement formula processing. Visits requiring these reimbursement calculations are initially associated with an indeterminate Calculation Path Step Qualifier String 226 containing one or more “?” characters. Such a string is indeterminate because there is not enough information at the beginning of the calculation to determine answer(s) to qualifier question(s). When one or more answer(s) to the outstanding patient visit qualification question(s) can be determined, the appropriate resolved path string mapping is selected from the Unresolved to Resolved Path Qualifier String Mappings table 232. If the initial path qualifier string contains multiple ‘?’ characters, multiple resolutions against this table is needed to determine the calculation path.

Calculation Path Step Qualifiers 234 is a table that associates Calculation Path Step Qualifier Strings 226 with Calculation Path Steps 222. These associations may be made using: a mask representing multiple path qualifier strings, an identification referencing a qualifier mask in a Qualifier Mask Mapping Table 230, or an identification referencing the full path qualifier string. One or more path qualifier string references (e.g., one for the different types of Calculation Path Step Qualifier String 226) may be associated with individual Calculation Path Steps 222 in the table.

Program Code Associating Input Visits 134 with Path Qualifier Strings 226, represented collectively as component 208, references data from the Calculation Path Step Qualifier String Mapping Tables 228, and data of Patient Visit Work Unit Tables 238, to assign an Initial Path Qualifier String 226 to a work unit visit. These associations are stored in a patient visit work unit intermediate table 236. If a Path Qualifier string has no “?” characters, that string is used to determine the visit's full calculation path. If the string has one or more “?” characters, this code uses Unresolved to Resolved Path Qualifier String Mappings 232 to replace an unresolved path map string, with a full one, at that point in the processing when the required data for resolving the “?” character is available.

Program code, in a stored procedure, handle known instances in the system's 100 Calculation Path Step Qualifier Model 206, where indeterminate calculation paths are in effect for stop loss provisions. An instance of an indeterminate calculation path qualifier character is associated with a Calculation Path Step 222 where the qualifier character is replaced with a determinate character. This processing occurs in response to completion of the Calculation Path Step's 222 target Calculated Financial Amount Type 216.

Program Code Determining Required Calculation Path Steps 210 determines the ordered subset of steps, from the Global Calculation Path Sequence 221, that are required for the current patient visit work unit. This subset is used to execute the Calculation Path Step Loop 212.

Calculation Path Step Loop 212 employs program code that uses information from tables in the Calculation Path Model 202 to execute a required Calculation Path Step 222 in the correct order. For individual Calculation Path Steps 222, an assigned stored procedure contains code for performing the path step's calculations. The following attributes related to the Calculation Path Step 222 are used to control, via parameter passing, which code blocks in the stored procedure are activated: a Calculation Step Label, and a Target Calculated Financial Amount Type Label.

If the superset of path qualifier strings associated with work unit visits, determined by the program code of component 210 above, precludes certain calculation path steps of the global sequence, those steps are excluded from the loop.

During iterations of the Calculation Path Step Loop 212, a subset of input visits 240 qualifying for the current Calculation Path Step 222 are identified at process step 242. If visits qualifying for the current Calculation Path Step 222 are found at process step 244, at process step 246, the system 100 executes applicable program code block(s), associated with contract term subsets 245, that calculate the reimbursement component for the current Calculation Path Step 222, and updates the appropriate storage table, with intermediate financial amounts corresponding to the step's 222 target Calculated Financial Amount Type 216. If, at the end of a calculation path step, enough information exists in the Financial Amount Storage Tables 224 to resolve partial calculation path(s) for input visits, at process step 248, program code is executed to provide answers to the outstanding qualifier questions, and update an applicable visit's path qualifier string, to reflect the answers to those questions.

At process step 250, determines whether the presently processed step is the last step. If the determination at process step 250 is negative, the system 100 processes subsequent Calculation Path Steps 222 in the loop 212 in a similar manner. If the determination at process step 250 is positive, the system 100 continues to process step 252.

At process step 252, the system 100 determines whether the presently processed patient visit is the last patient visit in the work unit. If the determination at process step 252 is negative, the system 100 continues to processes 206, 208, and 214, as described herein. If the determination at process step 252 is positive, the system 100 ends the method 200 at step 254.

The system 100 takes advantage of database technology, especially in the use of dynamically generated code and indexes to access data. In an alternative embodiment, an equivalent of the Calculation Path Step Loop 212 may be run against individual contract rules to produce one database table of results for individual rules. For iterations of the Calculation Path Step Loop 212, the current contract rule is applied to the current 50,000-patient visit work unit. When results for contract rule(s), serving as input for a higher-level component calculation, such as aggregation, are available, the system 100 performs the higher-level component calculation.

The Large Work Unit Scope of Calculation Path Steps 214 provides a default maximum work unit size of 50,000 patient visits, for example. For the majority of simulated contracts, it is expected that the Calculation Path Step Loop 212 is iterated once, for a provider hospital, to process input visits for that hospital. The work unit size of patient visits are provided to work unit tables 238.

When combined in the reimbursement calculation process, the above features exhibit the following effects, for example. The effects may be ascertained from log messages and process information stored in the database 106.

1. SQL UPDATE and INSERT statements executed against intermediate tables contained in the Financial Amount Storage Tables List 224 should show query parallelism. Parallelism, in SQL Server databases, can be assessed by executing the sp_who2 command, passing in a Server Process ID (i.e., “spid”) of the server process associated with the calculation work being performed. Running a SQL Profiler tool for events associated with the Server Process ID can also assess parallelism, in SQL Server databases. In addition to the multiple processors for parallelism, certain database server configuration settings need to be set to support parallelism.

2. Association of visits with calculation paths, using the Calculation Path Step Qualifier Model 206, is efficient and accurate, supporting use of indeterminate paths.

3. Processing steps that determine which visits qualify for a contract term are separated from step(s) that calculate financial amounts from that contract term. For complex contracts, this feature improves performance.

4. Calculation path steps not required for visits of the current patient visit work unit are skipped, making the overall process more efficient.

5. A calculation path step is executed for the patient visit work unit, even if multiple reimbursement formulas (e.g., implemented as calculation paths containing the calculation path step) are being applied. This contributes to high processing efficiency, because multiple calculation paths can be completed, concurrently, through one pass of the global calculation path sequence.

6. The structure and function Calculation Path Step Model 202 and the Calculation Path Step Qualifier Model 206 tables support self-documenting. Customers and developers may use reports of the models as communication, development, and educational tools.

7. The Calculation Path Model 202 and the Calculation Path Step Qualifier Model 206 are flexible in content. They may be readily enhanced to include new reimbursement formula components and contract term qualification criteria.

8. The Calculation Path Model 202 and the Calculation Path Step Qualifier Model 206 drive program code execution. Changes to these data models 202 and 206 assists identifying the program code modules, or program code blocks, that need to be modified or created to support data model changes.

Beneficial features of the system 100 include the following, for example:

1) The Calculation Path Model 202 is used to define and implement, with efficient set-based data modification statements against large database tables, a set of complex reimbursement calculations as a set of reusable reimbursement formula components. The system 100 advantageously uses the fact that healthcare reimbursement formulas have common, reusable features that can be implemented independent of one another. The models are linked to reusable program code, ensuring that components of a reimbursement formula are calculated in the proper order, along with the correct inputs.

2) The Calculation Path Step Qualifier Model 206 is combined with the Calculation Path Model 202 to effectively manage activities related to qualifying input visits for possible calculation paths covered by the Calculation Path Model 202.

The system 100 supports coordinated processing of up to 546, for example, modeled calculation paths for a simulated contract. The actual number of calculation paths that can be executed, in a the system simulated contract, is much higher than 546, because the underlying models do not include a unique Financial Amount Type 216 designation for detail-level reimbursement amounts computed from a contract rule in the contract rules repository. In the system 100, these reimbursement contributions are aggregated to produce intermediate amounts that are used as input for a patient visit level Calculation Path Step formula The system 100 may also support modeling of contract rule-level calculations.

3) Executing a processing loop that iterates an applicable Calculation Path Step once, against a large work unit of visits, causes efficient and simultaneous calculation of results from many reimbursement formulas when the Calculation Path Model 202 and the Calculation Path Step Qualifier Model 206 are applied in set-based data manipulation SQL code. The more that common reimbursement formula components are modelled and implemented as shared path steps of the Calculation Path Model 202, the more that the work performed in executing individual calculation paths overlap the work being performed for other calculation paths. When calculation paths share many path steps, access to large input tables and indexes is decreased, and the probability for shortened processing time is increased.

4) Use of Calculated Financial Amount Type 216 conversion steps as Calculation Path Steps (e.g. changing the financial amount type for a financial amount from one type to another), is used to develop Calculation Path Models 202, and increases the potential for sharing Calculation Path Steps among calculation paths.

5) The Calculation Path Model 202 and the Calculation Path Step Qualifier Model 206 are linked to program code. The code is accurately executed for calculation paths that are initially indeterminate, meaning that some of the information needed, at the patient visit level, to determine the full calculation path for that patient visit is not available at the start of calculation processing. This advantageously applies to healthcare reimbursement calculations involving stop loss provisions.

The following description provides an exemplary operation of the system 100 and method 200.

Provider (e.g., a hospital) “Y” is currently receiving reimbursement, from payer Health Maintenance Organization (HMO) “X, under the following contract terms:

1. Open heart surgery: $2600/day

2. Critical Care: $2000/day

3. C-section—mom: $1500 for stay

4. Normal newborn—baby: $300 for stay

5 Other Surgery: $1600/day

6. A one-time amount associated with the contract terms above, and for visits not qualifying for any of the above terms: $300

7. A stop Loss Provision provides that total payments cannot yield less than 70% of hospital charges. If payments are less than 70% of charges using terms 1-6 for a visit, use 70% of charges as the reimbursement.

The contract is up for renewal starting January 2005. HMO X is proposing to amend the terms so that the contract term Other Surgery is reduced to $1550/day and that the contract term Open Heart surgery is increased to $2750/day.

Provider Y wants to know the projected impact of these term changes on a total reimbursement from HMO X.

Provider Y prepares and generates simulated results for the existing contract with HMO X. Results contain a reimbursement amount for individual patient visits where HMO X is the primary insurance. There are 500,000 such visits.

The system 100 calculates the reimbursement, for 50,000-large blocks of visits using HMO X, executing the following sequence of steps against the data in individual large blocks.

1. For visits in the block, determine which of the first five terms should be initially applied to individual patient visits. A patient visit is assigned to no more than one of the first five terms, using the one having the highest priority (e.g., 1 highest, 2 next highest, etc.) that the patient visit qualifies for.

2. For visits in the block, the system 100 calculates a non-adding payment amount (related to the stop loss contract term) for individual contract terms. If the patient visit does not qualify for terms 1-5, the system 100 calculates the non-adding amount as zero.

3. For visits in the block, the system 100 adds the $300 adding amount to the results of the previous step 2. This is the non-stop loss amount. The system 100 also determines which results, of this step, are less than 70% of hospital charges.

4. For the visits with a non-stop loss amount less than 70% of hospital charges, the system 100 recalculates the amount to be 70% of hospital charges. This amount is the pre-contract amount.

5. For visits in the block, the system 100 multiplies the results from the previous step four by an inflation factor to generate the final contract amount.

This sequence is performed ten times, once for a 50,000 block of the 500,000 patient visit population. The total run time is two hours with the Provider Y's database server configuration, competing processes, etc.

Provider Y adds up the entire patient visit contract amounts (called “C”) to calculate an estimated reimbursement, from HMO Y, for visits of the current contract.

Next, Provider Y sets up and generates simulated results for the modified contract. The same sequence of steps is performed as described above. The total run time is 2.3 hours.

Provider Y adds up the payment amounts (called “P”) to calculate an estimated reimbursement, from HMO Y, for the proposed renewal contract.

Provider Y compares contract amounts “C” to payment amounts “P.” If P is greater than C, the provider should get more money accepting the new contract. If P is less than C, the provider should get less money.

For this example, the set of visits included in steps 1, 2, 3, and 5 of the above sequence are the same, within an iteration of the sequence, whether or not they qualify for contract terms 1-5, or the stop loss provision, because calculation paths for the visits share these steps. The possible calculation paths include the following sequences of steps:

1. Steps 1, 2, 3, 4, and 5 include visits that qualify for the stop loss provision (i.e., step 4).

2. Steps 1, 2, 3, and 5 do not include visits that qualify for the stop loss provision (i.e., step 4).

The system 100 causes these calculation paths to be executed in parallel, where visits in a 50,000-patient visit work unit that qualify for a shared step are processed at the same time.

The system 100 calculates healthcare reimbursement amounts for large patient populations by performing the following processes.

1. The system 100 programmatically decomposes reimbursement terms into a data model, stored in database tables, containing:
a) named, calculable expressions 132 found in reimbursement formulas,
b) named, intermediate financial amounts 152 calculated from individual calculable expressions 152, and
c) named combinations of financial claim conditions qualifying patient visit data for all, or a subset, of term calculable expressions.

A reimbursement term is composed of one or more ordered sets of calculable expression components, plus a set of financial claim conditions qualifying patient visit data for all, or a subset, of these components.

A reimbursement formula 140 is implemented as an ordered set of calculable expression components 132 and 148.

For a determinate reimbursement term, there is one reimbursement formula 140, and the data needed to determine whether a specific patient visit qualifies for calculable expression components 132 of the reimbursement term is available before the start of calculation.

For an indeterminate reimbursement term 152, there are multiple possible reimbursement formulae 140, and one or more conditions qualifying the patient visit for calculable expression component(s) 132 of the term requires pre-calculation of an intermediate financial amount 152 from one or more calculable expression components 132.

2. Using database table references, the system 100 associates a calculable expression component 132 with the intermediate financial amount 152 calculated using the calculation expression. Such an association is defined as a calculation path step for the reimbursement formula.

3. The system 100 automatically creates financial amount type assignment links and associated financial amount types to merge outputs of multiple calculation path steps into a single input for a subsequent calculation path step.

4. The system 100 uses database table references to link individual calculation path steps of processes 2 and 3 immediately above, to one or more combinations of conditions qualifying the input data for the financial claim(s) associated with the reimbursement term.

5. The system 100 links (i.e., associates) a financial amount type identifier to an intermediate result database table, and to SQL calculation code, that updates the intermediate result database table with financial amounts having the financial amount type identifier.

6. The system 100 determines a predefined order in which the intermediate result database tables are updated.

7. The system 100 programmatically creates a global sequence of calculation path steps that supports reimbursement terms in the simulated contract. This involve linking a calculable expression component's result financial amount to the input of a later calculable expression component in the reimbursement formula's calculation sequence, and ordering component steps to be consistent with the intermediate result database load table order of process 6 immediately above.

8. The system 100 creates, for individual determinate reimbursement terms, a subset of the global calculation component sequence that reproduces the reimbursement formula

9. The system 100 creates, for an indeterminate reimbursement term, multiple subsets of the global calculation component sequence, with a subset reproducing one of the reimbursement formula(s) associated with the term.

10. The system 100 links (i.e., associates) an input patient visit's data with a member of the set of calculation component financial claim qualifying condition combinations, for financial claim(s) associated with the reimbursement terms, prior to performing financial amount calculations.

11. The system 100 calculates reimbursement amounts by programmatically iterating individual steps of the global calculation path step sequence once, applying individual reimbursement formula calculable expression components to qualified visits, in set-based SQL statements.

12. The system 100 programmatically adjusts a patient visit reference to a financial claim qualifying conditions combination, during the calculation process, when an intermediate financial amount required to determine whether the patient visit meets a financial claim qualifying condition combination, for a later step in the global calculation path step sequence 221 is calculated.

Hence, while the present invention has been described with reference to various illustrative examples thereof, it is not intended that the present invention be limited to these specific examples. Those skilled in the art will recognize that variations, modifications, and combinations of the disclosed subject matter can be made, without departing from the spirit and scope of the present invention, as set forth in the appended claims.

What is claimed is:

1. A financial claim reimbursement simulation system, comprising:
an interface processor for receiving data representing a plurality of different financial claims for reimbursement based on a plurality of different predetermined reimbursement formulae;
a source of data representing a plurality of calculable expressions;
at least one repository including,
data associating a particular calculable expression with a plurality of different reimbursement formulae and
data associating particular financial claim data with particular reimbursement formulae; and
a data processor for using the at least one repository in identifying financial claim data of the data representing a plurality of different financial claims associated with particular reimbursement formula and for initiating execution of a procedure comprising the particular calculable expression derived from the source to provide calculated data for use in determining a reimbursement value based on different reimbursement formulae.

2. A system according to claim 1, wherein
the data processor initiates concurrent execution of procedures comprising the different reimbursement formulae.

3. A system according to claim 1, wherein
the data processor initiates concurrent execution of procedures comprising the particular calculable expression derived from the source to provide calculated data for use in determining a reimbursement value based on different reimbursement formulae.

4. A system according to claim 1, wherein
a reimbursement formula involves a plurality of calculable expressions executed in a predetermined order,
the at least one repository includes data identifying order of execution of the plurality of calculable expressions and
the data processor uses the order identification data derived from the repository in initiating execution of procedures comprising the plurality of calculable expressions derived from the source in the predetermined order.

5. A system according to claim 1, wherein
the at least one repository includes links to data representing executable procedures comprising the plurality of calculable expressions and the data processor uses the links in initiating execution of procedures.

6. A system according to claim 1, wherein
the plurality of calculable expressions are derived by decomposing the plurality of different predetermined reimbursement formulae into component calculable expressions.

7. A system according to claim 1, including
a decomposition processor for automatically decomposing the plurality of different predetermined reimbursement formulae into component calculable expressions by parsing formulae and using character matching.

8. A system according to claim 1, including
the data associating the particular financial claim data with the particular reimbursement formulae comprises data representing financial claim qualifying conditions.

9. A system according to claim 1, wherein
the execution of the procedure comprising the particular calculable expression provides an intermediate financial value for use by a second calculable expression in a reimbursement formula.

10. A system according to claim 9, wherein
the financial sum value is provided to the second calculable expression and the second calculable expression provides a second financial sum value used in deriving a reimbursement sum value in accordance with the reimbursement formula.

11. A system according to claim 9, wherein
the second calculable expression in the reimbursement formula uses a plurality of result values provided by a plurality of different calculable expressions including the intermediate financial value from the particular calculable expression.

11. A system according to claim 1, wherein
the data associating a particular calculable expression with a plurality of different reimbursement formulae and the data associating particular financial claim data with particular reimbursement formulae, is stored within tables in the at least one repository.

12. A system according to claim 1, wherein
a repository comprises a database.

13. A method for financial claim reimbursement, comprising the steps of:
receiving data representing a plurality of different financial claims for reimbursement based on a plurality of different predetermined reimbursement formulae;
receiving a plurality of calculable expressions;
providing data associating a particular calculable expression with a plurality of different reimbursement formulae;
providing data associating particular financial claim data with particular reimbursement formulae;
using the at least one repository in identifying financial claim data of the data representing a plurality of different financial claims associated with particular reimbursement formula; and
initiating execution of a procedure comprising the particular calculable expression derived from the source to provide calculated data for use in determining a reimbursement value based on different reimbursement formulae.

14. A method according to claim 13, further comprising the step of:
initiating concurrent execution of procedures comprising the different reimbursement formulae.

15. A system according to claim 13, further comprising the step of:
initiating concurrent execution of procedures comprising the particular calculable expression to provide calculated data for use in determining a reimbursement value based on different reimbursement formulae.

16. A system according to claim 13, further comprising the step of:
deriving the plurality of calculable expressions by decomposing the plurality of different predetermined reimbursement formulae into component calculable expressions.

17. A system according to claim 13, further comprising the step of:
automatically decomposing the plurality of different predetermined reimbursement formulae into component calculable expressions by parsing formulae and using character matching.
